(19) United States
(12) Patent Application Publication
(10) Pub. No.: US 2007/0277393 A1
(43) Pub. Date: Dec. 6, 2007

(54) Cabinet for automatic washing or/and drying machine and automatic washing or/and drying machine with the same

(75) Inventor: Peter Tunguy-Desmarais, Durban North (ZA)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/319,665

(22) Filed: Dec. 29, 2005

(30) Foreign Application Priority Data
Jul. 2, 2003 (ZA) 2003/5160

(51) Int. Cl. F26B 25/06

(52) U.S. Cl. 34/603; 34/201

(57) ABSTRACT

The present invention relates to a cabinet for an automatic washing or/and drying machine, and an automatic washing or/and drying machine with the same, and more particularly, to a cabinet for an automatic washing or/and drying machine, in which a cabinet for automatic washing or/and drying machine, having panels joined by curling, is improved to prevent the panels from slipping with respect to each other at joined portions; and an automatic washing or/and drying machine with the same. According to the present invention, a cabinet for an automatic washing or/and drying machine includes a first panel having an inner curling portion formed thereon, a second panel having an outer curling portion formed thereon for placing the inner curling portion therein, for joining with the first panel adjoining to the first panel, a joined portion having the inner curling portion and the outer curling portion compressed together, with the inner curling portion placed in the outer curling portion, and a slip preventive portion of the joined portion, the slip preventive portion having a vertical sectional shape different from a vertical sectional shape of the other portion.

### CROSS-REFERENCE TO RELATED APPLICATION

This application claims the benefit of Korean Application No. P2004-116091, filed on Dec. 30, 2004, which is hereby incorporated by reference as if fully set forth herein.

### BACKGROUND OF THE INVENTION

1. Field of the Invention

The present invention relates to a cabinet for an automatic washing or/and drying machine, and an automatic washing or/and drying machine with the same, and more particularly, to a cabinet for an automatic washing or/and drying machine, in which a cabinet for automatic washing or/and drying machine, having panels joined by curling, is improved to prevent the panels from slipping with respect to each other at joined portions; and an automatic washing or/and drying machine with the same.

2. Discussion of the Related Art

In general, a laundry dryer, a kind of automatic washing or/and drying machine for washing and/or drying laundry, supplies hot air produced by a hot air supply unit having an electric heater, gas burner, or the like to an drying object, such as laundry introduced to a drum, for drying the drying object, specifically, laundry.

A cabinet is indispensable for the laundry dryer to protect various unit provided therein from an outside of the dryer, and to form an exterior. Moreover, the cabinet has a function for protecting a user from possible hazard caused by the hot air supply unit, and protecting an exterior of the laundry dryer.

In the meantime, in general, a related art cabinet of the laundry dryer is constructed of a steel plate for carrying out above functions. As the steel plate permits easy curling, adjoining panels have been joined by curling.

Of course, the joining of panels by curling is not limited to the laundry dryer. That is, even in the case of the automatic washing or/and drying machine which performs washing and drying at the same time, or washing only, a cabinet thereof is joined by curling if the cabinet is constructed of the steel plate.

FIG. 1 illustrates a perspective view of a related art cabinet of a laundry dryer, showing a state a slip takes place at a joined portion by curling, and FIG. 2 illustrates a section across a line II-II in FIG. 2.

The cabinet 10 is an assembly of side panels 11, a bottom panel 12, and a rear panel 13 of steel plate joined by curling of the panels 11, 12, and 13 for easy fabrication of the cabinet 10.

Referring to FIG. 2, in the curling, after an outer curling portion 14a and an inner curling portion 14b are formed such that joining edges of respective panels 11, and 12 surround each other, the inner curling portion is placed in the outer curling portion, and the outer curling portion is pressed down, to form a joined portion 14, for maintaining a joined state of the panels with a surface pressure of the compression, which is mostly used between members which are easy to bend and compress, such as steel.

Such a curling has advantages of good processability compared to welding or bolting, and clean exterior.

However, due to a nature of the curling in which, while the curling has a strong joining force in a vertical direction of the joined portion, the curling has a weak joining force in a length direction of the joined portion, the related art cabinet 10 of the laundry dryer assembly by curling has a drawback in that the cabinet 10 shows slip when an external force is applied to the joined portion in a length direction thereof.

That is, referring to FIG 1, if the external force is applied in the length direction of the joined portion, i.e., an arrow direction 16 thereon, the joined portion is liable to slip in the arrow direction, as the inner curling portion and the outer curling portion slip with respect to each other.

Once such a slip takes place, shaking, and shaking noise occur at the joined portion 14, and sustenance of proper shape of the cabinet 10 fails, resulting in a weak overall strength of the laundry dryer.

Moreover, dimensional assembly differences occur between units and components assembled with reference to the cabinet 10 slipped thus, to leading the assembly poor, or impair durability and security.

### SUMMARY OF THE INVENTION

Accordingly, the present invention is directed to a cabinet for an automatic washing or/and drying machine, and an automatic washing or/and drying machine with the same that substantially obviates one or more problems due to limitations and disadvantages of the related art.

An object of the present invention is to provide a cabinet for an automatic washing or/and drying machine, and an automatic washing or/and drying machine with the same, in which a structure of a joined portion of cabinet panels of an automatic washing or/and drying machine assembled by curling is improved, to prevent the joined portion from slipping.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a cabinet for an automatic washing or/and drying machine includes a first panel having an inner curling portion formed thereon, a second panel having an outer curling portion formed thereon for placing the inner curling portion therein, for joining with the first panel adjoining to the first panel, a joined portion having the inner curling portion and the outer curling portion compressed together, entirely or partially, with the inner curling portion placed in the outer curling portion, and a slip preventive portion of the joined portion, the slip preventive portion having a sectional shape different from a sectional shape of the other portion.

A plurality of the slip preventive portion are formed along a length direction of the joined portion, or at a front end and a rear end of the joined portion. Or, the slip preventive portion may be provided between the front end and the rear end of the joined portion.

Preferably, the slip preventive portion prevents the inner curling portion and the outer curling portion from slipping with respect to each other when an external force is applied to the joined portion in a length direction thereof. The slip preventive portion further includes a slip preventive step formed due to a sectional difference between the joined portion and the slip preventive portion.

The slip preventive portion may be an un-compressed portion of the joined portion, or the slip preventive portion may includes a cut-away portion from a portion of an outer curling portion of the second panel, and an un-curled portion of the inner curling portion of the first panel in conformity with the cut-away portion.

In another aspect of the present invention, a cabinet for an automatic washing or/and drying machine includes a first panel having an inner curling portion formed thereon, a second panel having an outer curling portion formed thereon for placing the inner curling portion therein, for joining with the first panel adjoining to the first panel, a joined portion having the inner curling portion and the outer curling portion compressed together, with the inner curling portion placed in the outer curling portion, and a slip preventive portion formed at a section of the joined portion, the slip preventive portion having a vertical sectional shape different from the joined portion for interfering with a vertical section of the joined portion to stop slip of the joined portion when an external force is applied to the joined portion in a length direction thereof.

In another aspect of the present invention, an automatic washing or/and drying machine includes a cabinet for forming an exterior of the automatic washing or/and drying machine, and protecting various units provided therein, a drum in the cabinet for holding laundry therein, and a hot air supply unit for supplying hot air to dry the laundry, wherein the cabinet includes a first panel having an inner curling portion formed thereon, a second panel having an outer curling portion formed thereon for placing the inner curling portion therein, for joining with the first panel adjoining to the first panel, a joined portion having the inner curling portion and the outer curling portion compressed together, with the inner curling portion placed in the outer curling portion, and a slip preventive portion of the joined portion, the slip preventive portion having a vertical sectional shape different from a vertical sectional shape of the other portion.

Eventually, the present invention improves a cabinet of an automatic washing and/or drying machine having panels assembly by curling for enabling to prevent a joined portion of the panels from slipping with respect to each other, to enhance durability and security of the cabinet, thereby providing a cabinet for an automatic washing or/and drying machine, and an automatic washing or/and drying machine with the same.

In more detail, the present invention has an advantage of preventing the joined portion from slipping by means of a slip preventive portion having a vertical sectional shape different from a vertical sectional shape of the joined portion of adjoining panel by means of curling.

The slip preventing effect enables to resolve the problems of shaking, and shaking noise caused by the slip at the joined portion of the related art cabinet, and weakness of strength, assembly defect, and the like of the automatic washing or/and drying machine on the whole.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view of a related art cabinet of a laundry dryer, showing a state slip takes place at a joined portion by curling;

FIG. 2 illustrates a section of the joined portion across a line II-II in FIG. 2;

FIG. 3 illustrates a perspective view of a slip preventive portion in a laundry dryer in accordance with a preferred embodiment of the present invention;

FIG. 4 illustrates a section of the slip preventive portion across a line IV-IV in FIG. 3;

FIG. 5 illustrates a section of the slip preventive portion across a line V-V in FIG. 3; and

FIG. 6 illustrates a perspective view of a slip preventive portion in a laundry dryer in accordance with another preferred embodiment of the present invention.

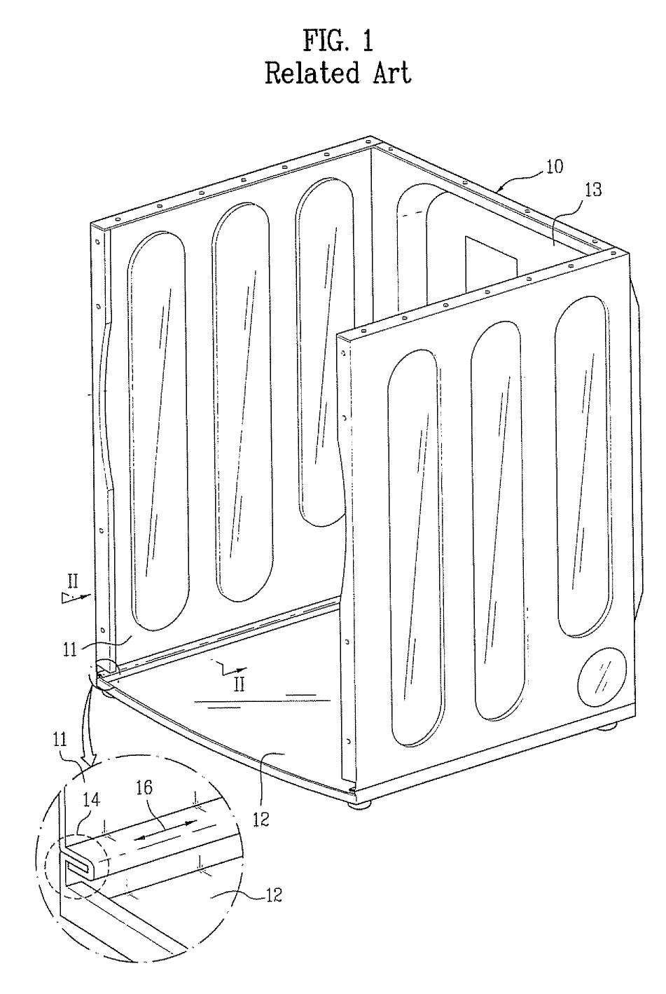

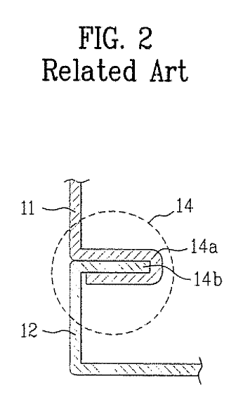

### DETAILED DESCRIPTION OF THE INVENTION

Reference will now be made in detail to the preferred embodiments of the present invention, examples of which are illustrated in the accompanying drawings. The present invention is not limited to a laundry dryer described hereafter, but applicable to all automatic washing or/and drying machine which washes and/or dries laundry. For convenience of description the laundry dryer will be described, as an example

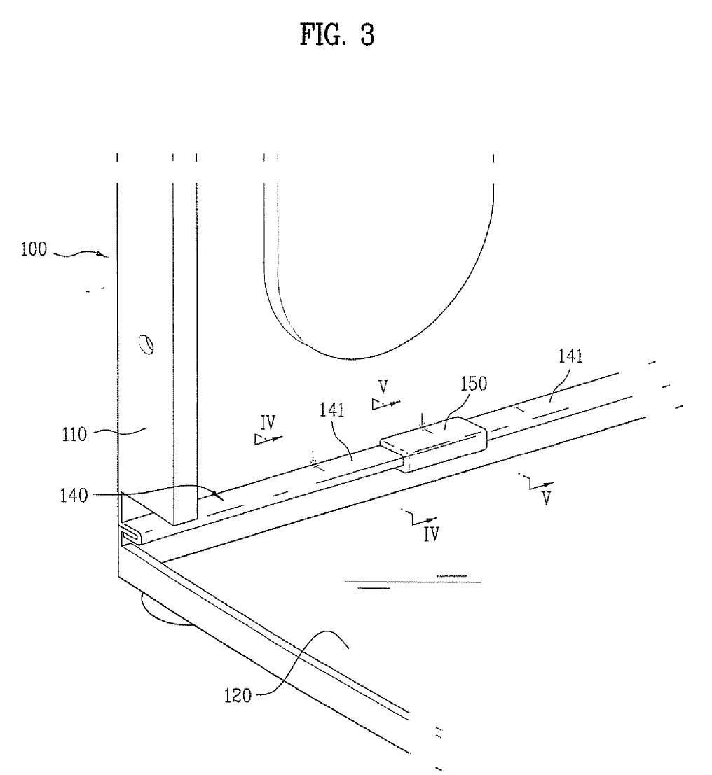

Referring to FIGS. 3 to 5, the laundry dryer in accordance with a preferred embodiment of the present invention will be described.

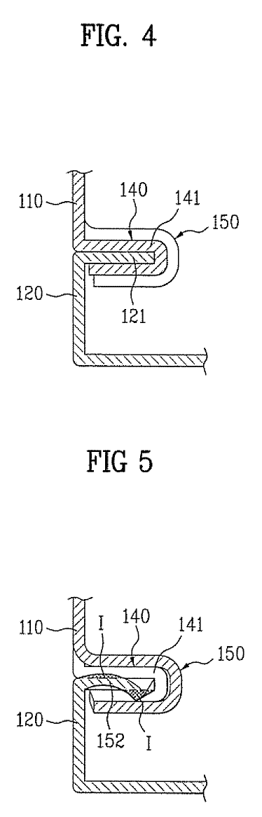

FIG. 3 illustrates a perspective view of a slip preventive portion in a laundry dryer in accordance with a preferred embodiment of the present invention, FIG. 4 illustrates a section of the slip preventive portion across a line IV-IV in FIG. 3, and FIG. 5 illustrates a section of the slip preventive portion across a line V-V in FIG. 3.

The automatic washing or/and drying machine, particularly, the laundry dryer includes a cabinet 100 for forming an exterior thereof and protecting various units therein, a drum (not shown) in the cabinet for holding laundry, and a hot air supply unit (not shown) for supplying hot air to dry the laundry.

However, as the present invention is not related to the drum or the hot air supply unit, detailed description of which will be omitted.

In the preferred embodiment of the present invention, a cabinet 100 is illustrated and described, in which an outer curling portion 141 is at a joining edge of a side panel 110 of the cabinet 100, and an inner curling portion 142 is at a joining edge of a bottom panel 120 of the cabinet 100 which is to be joined with the side panel 110, to have a curled portion 140 parallel to a floor in a front/rear direction of the cabinet 100.

Moreover, for convenience of description, the panel having the inner curling portion 142 will be called as a first panel 120, and the panel having the outer curling portion 141 will be called as a second panel 110, and the panel is not limited to the bottom panel or the side panel.

The cabinet of a laundry dryer of the present invention includes a first panel 120 having the inner curling portion 142, and a second panel having an outer curling portion 141 to be placed in the inner curling portion for adjoining to, and joining with the first panel.

The cabinet farther includes a joined portion 140 having the inner curling portion and the outer curling portion compressed together with the inner curling portion placed in the outer curling portion, and a slip preventive portion 150 in the joined portion having a section different from the other section of the joined portion.

It is preferable that the joined portion 140 is in a length direction thereof parallel to an edge of the cabinet in view of assembly and processing, and the sectional difference is in a vertical direction of the joined portion, though the sectional difference can be in the length direction of the joined portion.

Though FIG. 3 illustrates the slip preventive portion 150 at one place between a front end and a rear end of the joined portion 140, a number and positions of the slip preventive portion 150 is not limited to above, but a plurality of the slip preventive portions 150 may be provided, or the slip preventive portion 150 may be provided at the front end and the rear end of the joined portion 140.

The slip preventive portion 150 prevents the inner curling portion and the outer curling portion from slipping with respect to each other when an external force is applied to the joined portion in a length direction thereof.

A slip preventive function is performed as interference takes place between sections of the slip preventive portion 150 and the joined portion 140, which have difference shapes.

That is, at a time the inner curling portion 142 tends to slip in the length direction of the joined portion relative to the outer curling portion 141, the slip is prevented owing to a slip preventive step (I) or an interference portion having a vertical sectional difference

In the meantime, the slip preventive portion 150 may be an un-compressed portion of the joined portion 140. That is, as shown in FIG. 3, preferably the slip preventive portion 150 is the un-compressed portion of a section of the joined portion at the time the inner curling portion 142 and the outer curling portion 141 are compressed in a vertical direction with the inner curling portion 142 placed in the outer curling portion 141.

The un-compressed portion, i.e., the slip preventive portion 150 has an inner curling portion 152 having a section different from the inner curling portion 141 as the inner curling portion 152 is not compressed, to form the slip preventive step (I) or the interference portion described before.

Of course, because the outer curling portion 141 of the slip preventive portion 150 is not compressed, the outer curling portion 141 has a sectional shape at the un-compressed portion different from the sectional shape of the outer curling portion 141 at the other compressed portion.

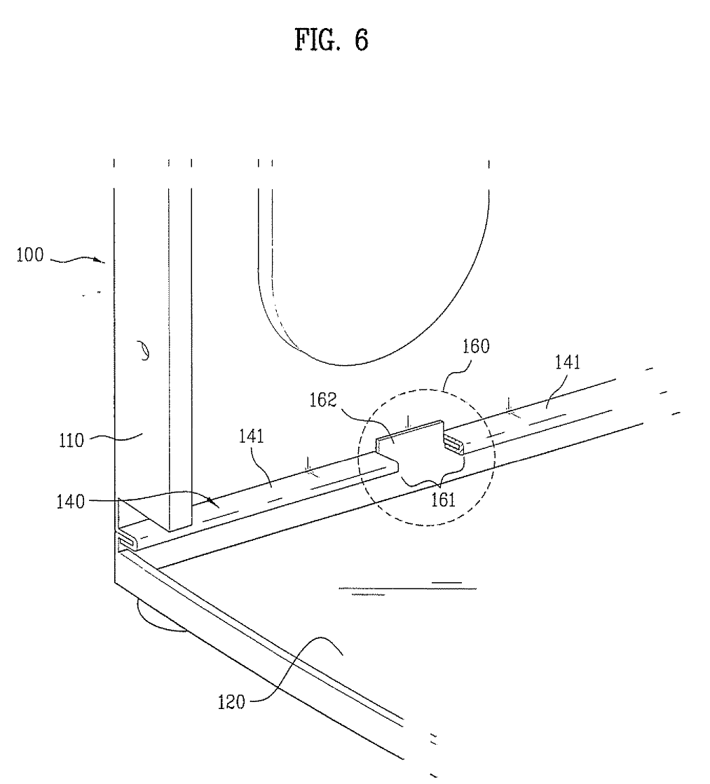

In the meantime, FIG. 6 illustrates a perspective view of a slip preventive portion in a laundry dryer in accordance with another preferred embodiment of the present invention, including a slip preventive portion having a cut-away portion 161 from a portion of an outer curling portion of the second panel 110, and an un-curled portion 162 of an inner curling portion of the first panel 120 in conformity with the cut-away portion.

That is, referring to FIG. 6, slip preventive portion 160 has the un-curled portion 162 placed in the cut-away portion 161.

In the embodiment too, the slip preventive portion 160 has a sectional shape different from the joined portion 140. Accordingly, the sectional shape difference enables to prevent the joined portion from slipping at the time an external force is applied thereto in a length direction of the joined portion.

The un-curled portion 160 enables the curling portion 140 from slipping at the time an external force is applied in a direction the curling portion 140 is formed because both ends of the inner curling portion 162 interfere at inside of the cut-away portion of the un-curled portion 160.

That is, because the un-curled portion 162 performs a function of the slip preventive step described before, the slip of the joined portion 140 is prevented.

In the meantime, alike the foregoing embodiment, a number and positions of the slip preventive portion 160 may vary.

Moreover, the slip preventive portions of above two embodiments may be applied to one joined portion.

It will be apparent to those skilled in the art that various modifications and variations can be made in the present invention without departing from the spirit or scope of the inventions. Thus, it is intended that the present invention covets the modifications and variations of this invention provided they come within the scope of the appended claims and their equivalents.

What is claimed is:

1. A cabinet for an automatic washing or/and drying machine comprising:
a first panel having an inner curling portion formed thereon;
a second panel having an outer curling portion formed thereon for placing the inner curling portion therein, for joining with the first panel adjoining to the first panel;
a joined portion having the inner curling portion and the outer curling portion compressed together entirely or partially, with the inner curling portion placed in the outer curling portion; and
a slip preventive portion of the joined portion, the slip preventive portion having a sectional shape different from a sectional shape of the other portion.

2. The cabinet as claimed in claim 1, wherein a plurality of the slip preventive portion are formed along a length direction of the joined portion.

3. The cabinet as claimed in claim 2, wherein the slip preventive portion is provided at a front end and a rear end of the joined portion.

4. The cabinet as claimed in claim 1, wherein the slip preventive portion is provided between the front end and the rear end of the joined portion.

5. The cabinet as claimed in claim 1, wherein the slip preventive portion prevents the inner portion and the outer curling portion from slipping with respect to each other when an external force is applied to the joined portion in a length direction thereof.

6. The cabinet as claimed in claim 5, wherein the slip preventive portion further includes a slip preventive step formed due to a sectional difference between the joined portion and the slip preventive portion.

7. The cabinet as claimed in claim 6, wherein the slip preventive portion is an un-compressed portion of the joined portion.

8. The cabinet as claimed in claim 1, wherein the slip preventive portion includes;
a cut-away portion from a portion of an outer curling portion of the second panel, and
an un-curled portion of the inner curling portion of the first panel in conformity with the cut-away portion.

9. A cabinet for an automatic washing or/and drying machine comprising:
a first panel having an inner curling portion formed thereon;
a second panel having an outer curling portion formed thereon for placing the inner curling portion therein, for joining with the first panel adjoining to the first panel;
a joined portion having the inner curling portion and the outer curling portion compressed together, with the inner curling portion placed in the outer curling portion; and
a slip preventive portion formed at a section of the joined portion, the slip preventive portion having a vertical sectional shape different from the joined portion for interfering with a vertical section of the joined portion to stop slip of the joined portion when an external force is applied to the joined portion in a length direction thereof.

10. The cabinet as claimed in claim 9, wherein the joined portion is formed in a length direction parallel to a predetermined edge of the cabinet.

11. The cabinet as claimed in claim 10, wherein the slip preventive portion is an un-compressed portion of the joined portion.

12. The cabinet as claimed in claim 10, wherein the slip preventive portion includes;
a cut-away portion from a portion of an outer curling portion of the second panel, and
an un-curled portion of the inner curling portion of the first panel in conformity with the cut-away portion.

13. An automatic washing or/and drying machine comprising:
a cabinet for forming an exterior of the automatic washing or/and drying machine, and protecting various units provided therein;
a drum in the cabinet for holding laundry therein; and
a hot air supply unit for supplying hot air to dry the laundry,
wherein the cabinet includes;
a first panel having an inner curling portion formed thereon;
a second panel having an outer curling portion formed thereon for placing the inner curling portion therein, for joining with the first panel adjoining to the first panel;
a joined portion having the inner curling portion and the outer curling portion compressed together, with the inner curling portion placed in the outer curling portion; and
a slip preventive portion of the joined portion, the slip preventive portion having a vertical sectional shape different from a vertical sectional shape of the other portion.

14. The cabinet as claimed in claim 13, wherein the slip preventive portion is an un-compressed portion of the joined portion.

15. The cabinet as claimed in claim 13, wherein the slip preventive portion includes;
a cut-away portion from a portion of an outer curling portion of the second panel, and
an un-curled portion of the inner curling portion of the first panel in conformity with the cut-away portion.
